(19) United States
(12) Patent Application Publication
(10) Pub. No.: US 2016/0159669 A1
(43) Pub. Date: Jun. 9, 2016

(54) REMOVAL OF METALS FROM WASTEWATER

(71) Applicants: Elise Noelle BARBOT, Metaire, LA (US); Meredith Beck GUSTAFSSON, Mars, PA (US); Cynthia Marie HAVRAN, Burke, VA (US); Monica Alexandra ARBOLEDA-PEÑA, Tomball, TX (US)

(72) Inventors: Elise Noelle BARBOT, Metaire, LA (US); Meredith Beck GUSTAFSSON, Mars, PA (US); Cynthia Marie HAVRAN, Burke, VA (US); Monica Alexandra ARBOLEDA-PEÑA, Tomball, TX (US)

(73) Assignee: ExxonMobil Research and Engineering Company, Annandale, NJ (US)

(21) Appl. No.: 14/953,655

(22) Filed: Nov. 30, 2015

Related U.S. Application Data
(60) Provisional application No. 62/087,408, filed on Dec. 4, 2014.

(51) Int. Cl. C02F 1/52; C02F 3/00; C02F 1/72

(52) U.S. Cl. CPC C02F 1/5236; C02F 1/72; C02F 1/5227; C02F 3/00; C02F 2101/106

(57) ABSTRACT

A method for effecting a comprehensive removal of heavy metals from wastewater in a two stage process in which the wastewater is contacted in a first stage with a source of ferric ions under mildly acidic conditions (pH 5 to pH 8), preferably followed by the removal of the precipitated solids using a solid-liquid separation; a second stage follows in which the wastewater from the first step is contacted with a source of ferric ions under alkaline conditions (pH 8+) followed by the removal of the precipitated solids using a second solid-liquid separation. Used in conjunction with an initial oxidation step, the present method makes possible the removal of a whole suite of heavy metals present in both the anionic and cationic form in refinery wastewater. The treatment also removes metal compounds in the particulate phase. Metals concentrations can be significantly decreased from the mid to high ppb (parts per billion) range down to the low ppb range to meet the quality criteria for discharge.

### CROSS-REFERENCE TO RELATED APPLICATIONS

This application claims priority to U.S. Provisional Application Ser. No. 62/087,408 filed Dec. 4, 2014, herein incorporated by reference in its entirety.

This invention relates to the removal of metals from aqueous solutions and, in particular, to the removal of heavy metals from aqueous solutions by a method of co-precipitation.

### BACKGROUND OF THE INVENTION

There is increasing concern over the hazards posed by the rising levels of heavy metals within the world's water supplies. Most heavy metals are toxic to some degree to life form and as a consequence of increasing concern over the concentration of heavy metals in waters discharged into the environment, industry is being required to reduce the levels of heavy metals from aqueous wastes with heavy metals typically considered to include metals and metaloids (e.g., arsenic) which have an atomic number greater than that of calcium, particularly aluminum, arsenic, cadmium, chromium, copper, lead, mercury, nickel, selenium, vanadium and zinc. In the oil industry, heavy metals occur naturally in crude oil and are transferred to wastewater during refining operations. Regulations on refinery wastewater discharges vary with location but it is now common to see limits in the lower ppb range, for example, in the Water Framework Directive (WFD), the Refining BREF and the CWW BREF limits in Europe. The decrease of acceptable concentration limits makes it more and more difficult to process certain types of crude.

Common treatment of refinery and chemical plants wastewaters include oil and solids removal by sedimentation and flotation processes as well as organics oxidation by biological treatment. Such processes may remove the particulate portion of the metal content but are ineffective in decreasing the dissolved metal concentration. A tertiary treatment is thus necessary to comply with the decreasing regulatory limits. A particular difficulty encountered in wastewater treatment is to remove metals which have different solubilities in water under different conditions, e.g. in the presence of different reagents and under different pH conditions. Removal of all the eleven metals mentioned above has proved difficult at the levels in Table 1 below.

TABLE 1

| | Target |
|---|---|
| | Concentration |
| Metal | (ppb) |
| Al | 800 |
| As | 30 |
| Cd | 2 |
| Cr | 10 |
| Cu | 10 |
| Pb | 5 |
| Hg | 0.1 |
| Ni | 5 |
| Se | 30 |
| V | 50 |
| Zn | 60 |

The best available technology for metal removal is reverse osmosis, as it is capable of removing dissolved metals and ions down to very low levels but it remains an expensive technology. It generates a concentrated brine that requires very costly and additional energy-demanding processes (typically evaporation and crystallization) to generate a solid salt waste (zero liquid discharge).

Another metals removal technique is precipitation (e.g. with hydroxides, sulfides) and this is one of the most widespread technologies used in industries for metal removal. However, it is only suitable for wastewater containing high concentrations of metals and is ineffective for low feed concentrations. Ion exchange, another alternative, may be able to remove all metals to low ppb levels but is expensive at large scale for wastewaters containing low concentrations of heavy metals, as it also removes other ions present in the wastewater. Similar to reverse osmosis, it would require additional very costly and energy-demanding processes to generate a solid waste (zero liquid discharge).

U.S. Pat. No. 5,013,453 (Walker) discloses the commercial UniPure™ process for removing heavy metals from aqueous waste streams without the necessity of adjusting the pH of such streams to pH values above 8.0 as it had been found that the conventional alkali precipitation method which required large volumes of alkali to precipitate the heavy metals as hydroxides was, with the increasing stringency of regulatory standards, becoming excessively expensive, particularly given its inability to use the cheaper ammonium hydroxide instead of caustic soda. The method described in this patent comprises co-precipitating the heavy metal ions with a carrier precipitate which is formed in situ within the aqueous solution while maintaining the aqueous solution at near neutral pH. Ferrous (Fe²⁺) chloride is added at the start and injected air is used to oxidize it to ferric iron to form the precipitate; the process, however, will not provide a significant cost advantage because it requires air to be mixed into the reactor, increasing capital costs.

Single-stage iron co-precipitation at mildly acidic pH has been implemented to remove selenium from refinery wastewater but it is ineffective to remove all of the eleven heavy metals noted above since the metals have differing solubility characteristics at different pH values.

### SUMMARY OF THE INVENTION

We have now devised a method for effecting a comprehensive removal of heavy metals from wastewaters such as petroleum refinery wastewater using the following steps: a first step of contacting the wastewater with a source of ferric ion under mildly acidic conditions (pH 5 to pH 8) followed by the removal of the precipitated solids using a solid-liquid separation, and a second step of contacting the wastewater from the first step with a source of ferric ion under alkaline conditions (pH 8+) followed by the removal of the precipitated solids using a second solid-liquid separation. The term “metals” is used in this specification to include metalloids such as arsenic and selenium.

The present method makes possible the removal of a whole suite of heavy metals present in both the anionic and cationic form in the wastewater. The treatment also removes metal compounds in the particulate phase. Metals concentrations can be significantly decreased from the mid to high ppb (parts per billion) range down to the low ppb range to meet the quality criteria for discharge to the environment. The process is particularly useful for removing minor amounts of metals

A number of different process variations may be used. In a preferred configuration, the wastewater is contacted in the first stage with a source of ferric ions under acidic conditions to form a co-precipitate of metals with ferric hydroxide which is then removed by solid-liquid separation to form a liquid effluent which is then passed to a second stage in which it is contacted with a source of ferric ions under alkaline conditions to form a second co-precipitate of metals with ferric hydroxide which is then removed using a second solid-liquid separation to form a purified liquid effluent suitable for discharge to the environment. In this configuration, the optimal removal of the metals is achieved by subjecting the precipitated solids removed in both stages to thickening in separate thickening steps although they may be combined and subjected to thickening in a combined thickening step. In either case, liquid effluent from the thickening step(s) is recirculated to the first stage.

In another process configuration, the wastewater is contacted with ferric ions in the first stage under acidic conditions to form the first co-precipitate which is then transferred together with the liquid effluent to the second stage maintained under alkaline conditions to form a combined co-precipitate which is removed using a second solid-liquid separation. Additional ferric ions may be added to the second stage or alternatively, the entire aliquot of ferric ions may be added at the first stage.

### DRAWINGS

In the accompanying drawings:

FIG. 1 is a simplified schematic of a wastewater treatment unit using two-stage iron co-precipitation with pH control for optimum metals removal;

FIG. 2 shows schematics for four treatment unit configurations;

FIG. 3 is a diagram showing the optimal pH ranges for removal of various metals.

### DETAILED DESCRIPTION

In the present process, the heavy metals are removed from the wastewater by a two-stage co-precipitation with iron. When selenium is present in a reduced form of selenium, (e.g. selenocyanate, the major form of Se in untreated refinery wastewater), however, an oxidative pretreatment of the wastewater is required for adequate selenium removal since iron co-precipitation is more effective with Se(IV). Typically most refineries have a BIOX, biological oxidation, unit that is adequate for this purpose but if there is no BIOX unit, an alternative chemical oxidation process may be provided. A clarifier is preferably interposed between a BIOX unit and the first precipitation step in order to separate the BIOX effluent from the biological sludge.

The addition of ferric ions to a metals-containing wastewater forms a precipitate of ferric hydroxide precipitate, as shown in the following reaction:

Fe³⁺3H₂O═Fe(OH)₃(s)+3H⁺

This addition forms iron-hydroxide flocs that remove metals. The process of co-precipitation increases the surface area and adsorption sites for various metals on the iron-hydroxide flocs. The optimal pH for metal removal depends however on the specific metal. For example, selenium is best removed at a pH of 5, whereas nickel is best removed at a pH greater than 8. Iron co-precipitation is a selective metal ion removal process that adds iron salts to the wastewater to absorb the metal ion and form a ferric hydroxide precipitate. The iron salt dosage and pH determines which and how much of the metals are removed.

The present two-stage iron co-precipitation process differs from the Unipure process in its use of ferric ions to form the hydrous precipitate which enables the oxidation step by aeration in the second reactor to be eliminated. In addition, The Unipure process which uses a single clarifier combines the sludges from the two stages and this, as discussed below, provides a potential for release of metals from the sludge as a result of pH change.

Screening tests showing the extent of removal of the metal ions at various single pH values revealed that the optimum pH ranges for removal of the eleven important metals are as follows:

| | |
|---|---|
| As, Cd, Cr, Pb, Hg, V | 5 to 8+ |
| Cu, Al | 6.5 to 8+ |
| Zn | 7 to 8+ |
| Ni | 8+ |
| Se | 5 to 8. |

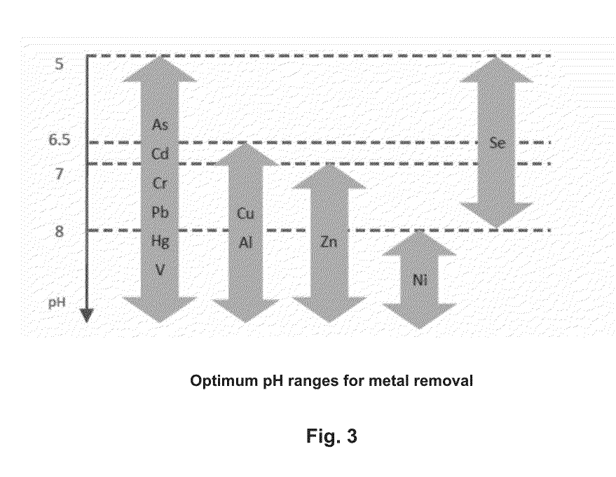

These ranges are shown graphically in FIG. 3.

Under optimal conditions, the concentrations of the target metals in refinery wastewaters can be reduced to the levels indicated below:

| | Concentration | Concentration range | Target |
|---|---|---|---|
| | range in | (ppb) after treatment at | concentration |
| Metal | wastewater (ppb) | optimal conditions | limit (ppb) |
| Al | 52-420 | <10 | 800 |
| As | <0.6-18 | <0.6-2.7 | 30 |
| Cd | <0.08-0.38 | <0.08 | 2 |
| Cr | <1-5 | <1-1.8 | 10 |
| Cu | <0.08-22 | 1.3-4.3 | 10 |
| Hg | <0.1-1.14 | <0.1 | 0.1 |
| Pb | <0.5-8.4 | <0.5-1.6 | 5 |
| Ni | 5.4-39 | <2-4.2 | 5 |
| Se | 54-98 | 16-26 | 30 |
| V | 16-1700 | <5 | 50 |
| Zn | 18-160 | <8 | 60 |

In the first stage of the removal following the oxidation, the wastewater stream is brought to a pH in the range of 5 to 8 to remove the metals whose removal is favored under acidic conditions, including Al, As, Cd, Cu, Pb, Hg, V and Se; flocculation and settling of the precipitate is not however favored by pH values of 4 or lower. A second stage removal under alkaline conditions (pH 8+) removes Ni and Zn. The optimum conditions are a first stage at pH 6.5 with 20 to 100, preferably about 50 mg/L FeCl₃ as Fe, followed by a second stage at pH 9 with a similar ferric ion concentration, again preferably about 50 mg/L Fe³⁺ as Fe, pH 9 is necessary to reach the target limit for nickel removal consistently (5 ppb).

In order to ensure a comprehensive removal of these metals, especially nickel and selenium which differ the most in their pH requirements for effective removal, down to acceptable limits, it is necessary to subject the water to varying pH during the precipitation. Selenium contribution to overall toxicity is great but it has been demonstrated that it can be removed with iron co-precipitation at low pH levels. Most other metals though, require a higher pH to achieve the desired level of removal.

Another factor in the removal process is the concentration of the iron ions in the treatment solution. It has been found that with the general range of metal contents in the wastewater, a concentration of ferric ions in the treatment solution from about 30 to about 100 mg/L is acceptable with a range of 50 to 80 mg/L being preferred. In many cases there is little advantage to be gained by using the higher concentration implying that the 50 mg/L is a workable and preferred norm. pH is the main driver for metal removal. The source of iron ions is conveniently ferric chloride (FeCl₃) but other water-soluble ferric salts may be used, for example, ferric sulfate, ferric nitrate, ferric ammonium sulfate.

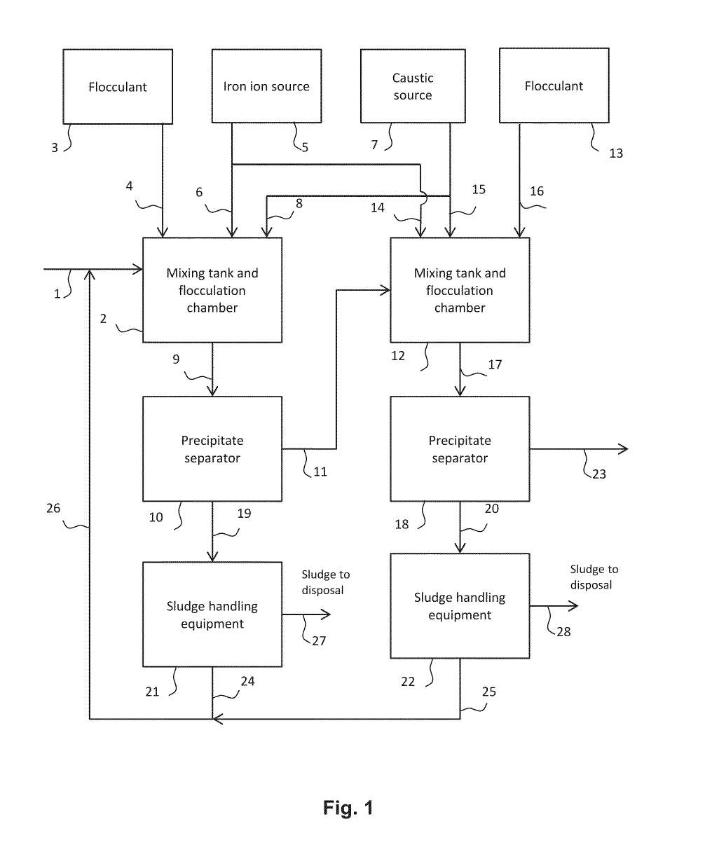

FIG. 1 shows a much simplified schematic of a wastewater treatment plant using two-state iron co-precipitation. The wastewater enters through line 1 to pass to a first mixing tank and flocculation chamber 2 connected to an iron ion supply tank 5 by conduit 6. A flocculant supply tank 3 is also connected to chamber 2 via conduit 4. In case caustic is required to adjust pH in chamber 2 e.g., to a value between 5 and 7, a caustic source 7 is connected to chamber 2 via conduit 8. Following the flocculation step, the supernatant effluent water is transferred via line 9 to a precipitate separator 10 for example, a clarifier, to remove the sludge from the liquid phase. The sludge from separator 10 is passed to sludge handling equipment designated at 21 for subsequent disposal by way of line 27. The water from separator 10 is passed via line 11 to second mixing tank/flocculation chamber 12 in which co-precipitation under alkaline conditions takes place. The mixing tank, flocculation chamber and precipitate separator can be a single equipment item, for example, a reactor/clarifier.

Mixing tank/flocculation chamber 12 is connected to the iron ion supply tank 5, caustic source 7 and flocculant supply 13; the reagents from these sources are added via conduits 14, 15 and 16, respectively. In mixing tank/chamber 12, the pH is raised between 8 and 10 and with the addition of the iron ions, a precipitate is formed which absorbs the remaining ions from the water; flocculation of the precipitate is assisted by the flocculating agent from source 13. The sludge that forms in tank 12 is removed by way of line 17 to precipitate separator 18 similar to separator 9. As with the first mixing tank/flocculation chamber, the second mixing tank/flocculation chamber and separator can be a single equipment. The liquid phase which leaves second precipitate separator 18 by way of line 23 is the treated effluent and can be discharged if the metal concentrations are below the relevant legal limits. The sludges removed from the two separators 19 and 20 are further dewatered in separate sludge handling units 21 and 22.

In one embodiment, a single sludge handling equipment receiving both sludges may be used. An example of sludge handling equipment is a thickener followed by a centrifuge. The water streams 24 and 25 from the sludge handling equipment are mixed in conduit 26 and sent back to the inlet of the treatment process where they are mixed with the incoming wastewater in line 1. The dewatered sludges removed through lines 27 and 28 can be sent for disposal.

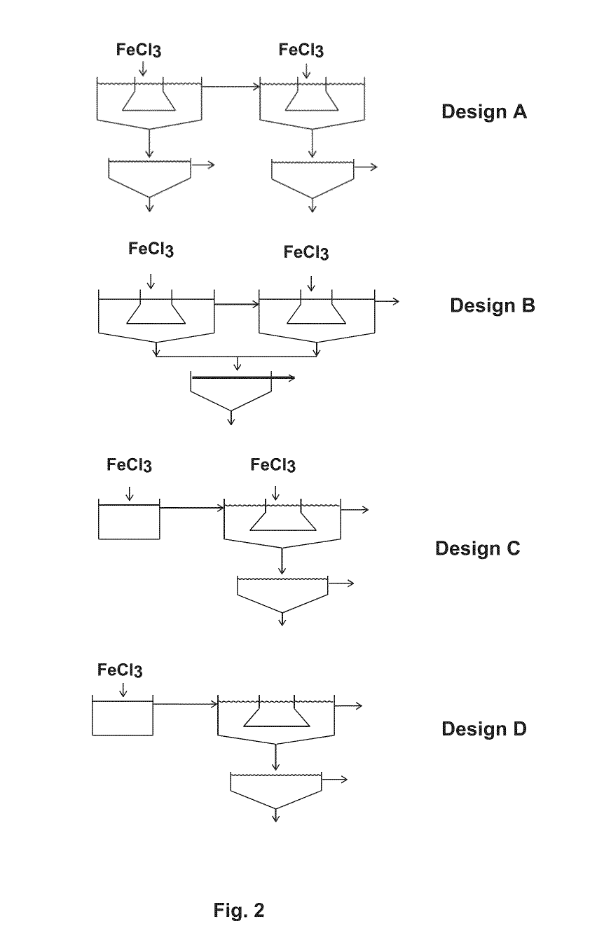

Two-stage iron-co-precipitation for removal of multiple metals can be set up following four different designs for which a schematic is given in FIG. 2. The goal of these different designs is to reduce the capital and/or operating cost by limiting the number of equipment needed and waste. Table 3 lists the equipment required for each design. The four designs are as follows, in decreasing order of cost:

Design A: The two stages are treated separately. FeCl₃ is injected in a first reactor/clarifier under acidic conditions. The sludge is sent to the first thickener (lower left). The supernatant liquid from the first reactor/clarifier is treated in a second reactor/clarifier where FeCl₃ is injected under alkaline conditions. The sludge from this second reactor/clarifier is sent to a second thickener (lower right). The overflow from each thickener is routed back to the respective clarifier.

Design B: similar to design A, but combines the low pH sludge from the first reactor with the high pH sludge from the second reactor into a single thickener. In this and all subsequent designs, the thickener overflow is sent back to the front end of the unit.

Design C: FeCl₃ is added to the first reactor maintained at low pH. Unlike the previous two designs, design C has no settling during this stage. Instead, the entire suspension is sent to a reactor/clarifier where the pH is increased for stage 2. This design would decrease the sludge volume required for disposal.

Design D: This is the same as Design C but there is no FeCl₃ addition to the second stage reactor/clarifier where the pH is increased; the calculated total quantity of ferric on is therefore added in the first stage and the pH adjusted to the desired value for precipitation under the acid pH, in the second stage the pH is brought up to the requisite value by the addition of alkali. This design also would decrease the volume of sludge required for disposal.

The use of two reactors/clarifiers with separate sludge handling (two thickeners and centrifuges) as in Design A yields effluents from both the clarifiers and thickeners that is capable of meeting all targets when operated under appropriate conditions but it is more expensive than Design B with the single thickener. Designs C and D represent further possibilities for limiting capital cost with, at the same time a potential for reduction in operating cost by limiting the volumes of sludge (ferric hydroxide with occluded metals) requiring disposal. With Designs B, C and D, the potential for release of metals, especially selenium, when the first stage sludge encounters a higher pH environment may present a limitation on the utility of these designs. Designs C and D may not meet the concentrations detailed in Table 1 but could potentially be applied to achieve less stringent limits.

Because metal removal depends on pH, a change of pH after co-precipitation may induce a release of some metals from the solid phase to the liquid phase. Nickel and selenium are the two metals for which the pH range for optimal removal is the narrowest. Consequently, they are the metals that are the most prone to being released from the sludge during a pH change. Selenium removal greatly decreases when the pH is greater than 8. Conversely, when pH is equal to or less than 8, Ni removal is decreased. Thus, there is a potential for Se release at pH above 8 and Ni release at pH equal or below 8. For design B, selenium and/or nickel are susceptible to go back in solution in the thickener. For designs C and D, there is a high probability of selenium release in the clarifier supernatant as a result of the higher pH which is encountered in the mixer and the clarifier. For these reasons, Design A is preferred when selenium removal to a low level is required.

The potential for release is present in the single thickener of design B when the two sludges are combined with the potential to compromise the quality of the thickener effluent but since the thickener effluent is only a small stream (around 3% of the feed flow rate), it can be rerouted to the inlet of the treatment train. If, however, the release of metals from the sludge into the thickener supernatant is significant, recirculation of the effluent could lead to an accumulation of metal throughout the process. Release can also happen during stage 2 of designs C and D, where the pH of the suspension from stage 1 is increased.

The iron co-precipitation process sometimes leads to an increase of some metals (e.g. Al, As, Cu, Ni, and Zn). This is due to the quality of the ferric salt. Manganese is a common metal in the ferric chloride but zinc is the second metal with the highest concentration, followed by Al, Cr, Ni, Cu and As in decreasing order. The increase of metal concentration after addition of FeCl₃ is perceptible when the initial metal concentration is low. When the initial metal concentration in the wastewater is high, the pollution induced by the ferric chloride is less or not noticeable. Conversely, a wastewater that initially met the target limits might not meet them anymore after treatment. However, if the pHs are carefully selected for the two stages, the extra metals introduced by the ferric chloride can be efficiently removed. For example, copper may not meet the target limit when the precipitation is performed at pH 4 or 5 but the target can be met at a higher pH even though the final concentration is slightly above the initial value. The increase of metal concentration due to the use of FeCl₃ does not seem to significantly impact the final effluent quality. Targets can be reached for a specific pH range, even if concentrations after treatment are above the initial values.

The residence time in the reactor must be long enough to allow reaction of the iron ion with the water and co-precipation of the metals from the wastewater (between five and thirty minutes). Substantially longer residence times will, of course, require larger vessels without significantly improving process efficiency.

The addition of a flocculant and/or a coagulant is desirable in order to promote phase separation between the effluent water and the precipitate. Since a number of commonly used metal coagulants are based on iron salts such as ferric sulfate, ferric chloride and ferric chloride sulfate, the addition of the ferric ions will have a coagulating effect. Other coagulants may however also be used to enhance the settling process if consistent with the desired effluent standards and the pH values to be attained in the respective stages of the process. Flocculants may be used to form bridges between flocs of precipitate to bind the particles into large agglomerates or clumps. An anionic polymer is the preferred flocculant for the first stage (low pH) and a cationic polymer for the second stage (high pH). Suitable commercially available materials include poly(diallyldimethylammonium chloride)(pDADMAC) such as BetzDearborn Polymer 1192P and polyacrylamides such as BetzDearborn AE115P.

### EXAMPLES

### Example 1

Co-precipitation studies were carried out on four samples of refinery waste water. The compositions of the samples were as follows:

| | | Sample 1 | Sample 2 | Sample 3 | Sample 4 |
|---|---|---|---|---|---|
| pH | | 7.7 | 7.4 | 7.5 | 7.5 |
| Conductivity | mS/cm. | 3.3 | 3.7 | 2.4 | 2.9 |
| TSS | mg/L | 14 | 120 | 72 | 12 |
| Oil + grease | mg/L | <5.0 | <5.0 | <5.0 | <5.0 |
| Turbidity | NTU | 12.8 | 106 | 72 | 12 |
| Al | μg/L | 46 | 420 | 270 | 61 |
| As | μg/L | 18 | 5.25.3 | 5.3 | <0.6 |
| Cd | μg/L | <0.08 | 0.38 | 0.085 | <0.08 |
| Cr | μg/L | 2.0 | 5.0 | <1.0 | <1.0 |
| Cu | μg/L | 3.1 | 22 | 13 | <0.8 |
| Pb | μg/L | 1.3 | 8.4 | 4.5 | <0.5 |
| Hg | μg/L | <0.1 | 1.14 | 0.33 | <0.1 |
| Ni | μg/L | 20 | 39 | 36 | 22 |
| Se | μg/L | 95* | 98 | 89 | 87 |
| V | μg/L | 1400 | 1200 | 1700 | 1700 |
| Zn | μg/L | 40 | 160 | 110 | 35 |
| Fe | μg/L | 200 | 2140 | 1200 | 240 |
| Na | mg/L | 540 | 600 | 340 | 440 |
| K | mg/L | 20 | 24 | 15 | 18 |
| Mg | mg/L | 44 | 62 | 31 | 42 |
| Ca | mg/L | 86 | 76 | 66 | 72 |
| Si | mg/L | 3.2 | 2.8 | 3.7 | 3.8 |
| Cl | mg/L | 730 | 930 | 520 | 660 |
| SO₄ | Mg/L | 320 | 266 | 190 | 240 |

Average Se ratio was 70% Se(IV) and 30% Se(VI).

Screening tests for metals removal were carried out in laboratory jars. To simulate the two-stage Designs A and B, two laboratory jars were used representing (1) the mixing tank at low pH (stirred jar), (2) the first stage settler, (3) the mixing tank at high pH (stirred jar) and (4) the second stage settler. After stirring in the first jar at low pH, the mixture was allowed to settle and the supernatant water transferred to a second, stirred jar at high pH. The main difference between design A and B is the mixing of the sludge in a single thickener, which can lead to release of metals in the thickener effluent due to pH change. To quantify the extent of metal release that would occur in design B, equal quantities of settled sludge were mixed. pH was measured and a supernatant sample was taken after the sludge was allowed to thicken for 3 days.

Samples 1 and 2 were tested under three conditions:

Condition 1: Fe(III)*50 mg/L at pH 5 followed by Fe(III) 50 mg/L at pH 9

Condition 2: Fe(III) 50 mg/L at pH 6.5 followed by Fe(III) 50 mg/L at pH 9

Condition 3: Fe(III) 80 mg/L at pH 6.5 followed by Fe(III) 50 mg/L at pH 8

Then samples 3 and 4 were tested under slightly modified conditions

Condition 1: Fe(III) 50 mg/L at pH 5 followed by Fe(III) 50 mg/L at pH 9

Condition 2′: Fe(III) 50 mg/L at pH 6.5 followed by Fe(III) 50 mg/L at pH 8

Condition 3′: Fe(III) 80 mg/L at pH 6.5 followed by Fe(III) 80 mg/L at pH 8

*Fe(III) 50 mg/L means that 50 mg Fe(III)/L.

The testing for the two-stage treatments reported in Table 2 below showed that nickel removal under condition 1 and condition 2 (pH=9) could be readily achieved but that removal fell below target under condition 2′ (pH=8). Under conditions 3 and 3′, removal targets were met.

TABLE 2
Two Stage Ni Removal for Designs A, B

| | Condi- | Condi- | Condi- | Condi- | Condi- |
|---|---|---|---|---|---|
| | tion 1 | tion 2 | tion 2′ | tion 3 | tion 3′ |
| | pH = 9 | pH = 9 | pH = 8 | pH = 8 | pH = 8 |
| Sample 1 | 90% | 90% | | 82% | |
| Sample 2 | 95% | 95% | | 87% | |
| Sample 3 | 93% | | 82% | | 94% |
| Sample 4 | | | 65% | | 80% |

The corresponding results for selenium removal which indicated that all selenium removal targets had been met are shown in Table 3 below.

TABLE 3
Two Stage Se Removal for Designs A, B

| | Condi- | Condi- | Condi- | Condi- | Condi- |
|---|---|---|---|---|---|
| | tion 1 | tion 2 | tion 2′ | tion 3 | tion 3′ |
| | pH = 9 | pH = 9 | pH = 8 | pH = 8 | pH = 8 |
| Sample 1 | 76% | 73% | | 75% | |
| Sample 2 | 84% | 84% | | 81% | |
| Sample 3 | 78% | | 78% | | 78% |
| Sample 4 | | | 72% | | 69% |

### Example 2

Simulation of the two-stage designs C and D was carried out as described in Example 1 except for the elimination of the settling/clarification function from the first jar (to represent Design C) and also addition of the ferric ion in the first stage only (to represent Design D). Otherwise, the same conditions were used. The results are shown below in Tables 4 and 5.

TABLE 4
Two Stage Ni Removal for Designs C, D

| | | | | |
|---|---|---|---|---|
| Condi- | Condi- | Condi- | Condi- | Condi- |
| tion 1 | tion 2 | tion 2′ | tion 3 | tion 3′ |
| pH = 9 | pH = 9 | pH = 8 | pH = 8 | pH = 8 |

Design C

| | | | | | |
|---|---|---|---|---|---|
| Sample 1 | 90% | | | 86% | |
| Sample 2 | 95% | 94% | | 92% | |
| Sample 3 | 94% | | 92% | | 92% |
| Sample 4 | 85% | | 75% | | 76% |

Design D

| | | |
|---|---|---|
| Sample 1 | 87% | |
| Sample 2 | 90% | |
| Sample 3 | | 84% |
| Sample 4 | | 67% |

TABLE 5
Two Stage Se Removal for Designs C, D

| | | | | |
|---|---|---|---|---|
| Condi- | Condi- | Condi- | Condi- | Condi- |
| tion 1 | tion 2 | tion 2′ | tion 3 | tion 3′ |
| pH = 9 | pH = 9 | pH = 8 | pH = 8 | pH = 8 |

Design C

| | | | | | |
|---|---|---|---|---|---|
| Sample 1 | 65% | 66% | | 72% | |
| Sample 2 | 70% | 72% | | 80% | |
| Sample 3 | 66% | | 75% | | 74% |
| Sample 4 | 56% | | 69% | | 71% |

Design D

| | | |
|---|---|---|
| Sample 1 | 53% | |
| Sample 2 | 62% | |
| Sample 3 | | 72% |
| Sample 4 | | 68% |

The results showed that Designs A and B showed an equal or better selenium removal than design C and D for all conditions tested with Design D giving the poorest selenium removal. The average Se removals are 77%, 70%, and 64% for designs NB, C, and D, respectively. Only design NB met the Se effluent target limit for all samples and all conditions. Ni target was reliably met only for Designs NB only for conditions 1 and 2. Designs C and D met Se target values for all samples only when condition 3′ is used (80 mg/L Fe at pH 6.5 and 80 mg/L Fe at pH 8), but in this case the Ni target limit was not met.

Nickel and selenium are the two metals for which the pH range for optimal removal is the narrowest. Consequently, they are the metals that are the most prone to being released from the sludge during a pH change. Se removal greatly decreases when the pH is greater than 8. Conversely, when pH is equal to or less than 8, Ni removal is decreased. The pH ranges at which both Ni and Se are stable in the ferric hydroxide flocs overlap between 7.5 and 8. Thus, there is a potential for Se release at pH above 8 and Ni release at pH equal or below 7.5. For design B, Se and/or nickel are susceptible to go back in solution in the thickener. For designs C and D, there is a high probability of Se release in the clarifier supernatant. Design A therefore represents the optimal design configuration for effective removal of these metals.

From this it follows that if the sludges from stage 1 and stage 2 are combined there will always be a release of Ni or Se in the thickener effluent unless the pH in the thickener is within the range of 7.5 and 8. Provided that the pH is close to the 7.5-8 range, the metal release will be negligible and can be tolerated as the thickener effluent is sent back the inlet of the treatment and no metal accumulation has been detected throughout the treatment). Designs C and D will therefore not be capable of meeting the target limits for both Sc and Ni, since at pH greater than 8, Se will desorb from the sludge and pass in the liquid phase.

1. A process for the removal of metal ions from wastewater comprising:
contacting the wastewater containing metal ions with a source of ferric ions under acidic conditions to form a first co-precipitate of metals with ferric hydroxide,
contacting the effluent from the first stage with a source of ferric ion under alkaline conditions to form a second co-precipitate of metals with ferric hydroxide, and
removing the precipitated solids using a second solid-liquid separation to form a final effluent of reduced metals content.

2. A process according to claim 1 which comprises:
in a first stage, contacting the wastewater containing metal ions with a source of ferric ions under acidic conditions to form a co-precipitate of metals with ferric hydroxide,
removing the precipitated solids by solid-liquid separation to form a liquid effluent,
in a second stage, contacting the liquid effluent from the first stage with a source of ferric ions under alkaline conditions to form a second co-precipitate of metals with ferric hydroxide, and
removing the precipitated solids using a second solid-liquid separation.

3. A process according to claim 2 in which the precipitated solids removed in the first and second stages are each subjected to thickening in separate thickening steps.

4. A process according to claim 2 in which the precipitated solids removed in the first and second stages are combined and subjected to thickening in a combined thickening step.

5. A process according to claim 3 in which liquid effluent from the thickening steps is recirculated to the first stage.

6. A process according to claim 4 in which liquid effluent from the combined thickening step is recirculated to the first stage.

7. A process according to claim 2 in which the wastewater contains nickel and selenium ions which are removed to a nickel content in the final effluent of not more than 5 ppb and the selenium content is not more than 30 ppb.

8. A process according to claim 3 in which the wastewater contains nickel and selenium ions which are removed to a nickel content in the final effluent of not more than 5 ppb and the selenium content is not more than 30 ppb.

9. A process according to claim 4 in which the wastewater contains nickel and selenium ions which are removed to a nickel content in the final effluent of not more than 5 ppb and the selenium content is not more than 30 ppb.

10. A process according to claim 5 in which the wastewater contains nickel and selenium ions which are removed to a nickel content in the final effluent of not more than 5 ppb and the selenium content is not more than 30 ppb.

11. A process according to claim 6 in which the wastewater contains nickel and selenium ions which are removed to a nickel content in the final effluent of not more than 5 ppb and the selenium content is not more than 30 ppb.

12. A process according to claim 1 in which the source of ferric ions is contacted with the wastewater in a first stage under acidic conditions to form a first co-precipitate of metals with ferric hydroxide and a liquid effluent, and the first co-precipitate is transferred with the liquid effluent to a second stage in which additional ferric ions are added under alkaline conditions to form a combined co-precipitate which is removed using a second solid-liquid separation.

13. A process according to claim 1 in which the source of ferric ions is contacted with the wastewater in a first stage under acidic conditions to form a first co-precipitate of metals with ferric hydroxide and a liquid effluent and the first co-precipitate is transferred with the liquid effluent to a second stage maintained under alkaline conditions to form a combined co-precipitate which is removed using a second solid-liquid separation.

14. A process according to claim 1 in which the first stage precipitation is carried out at ph 5 to pH 8.

15. A process according to claim 1 in which the first stage precipitation is carried out at ph 6.5 to pH 8.

16. A process according to claim 1 in which the second stage precipitation is carried out at ph 8 to pH 10.

17. A process according to claim 1 in which the wastewater is treated to oxidation prior to the first stage.

18. A process according to claim 17 in which the wastewater is treated to biological oxidation prior to the first stage to convert selenocyanate ions to selenium (IV) ions.

19. A process according to claim 17 in which the wastewater is treated to biological oxidation prior to the first stage.

20. A process according to claim 19 in which the wastewater is treated to biological oxidation prior to the first stage to convert selenocyanate to selenium (IV) ions.

21. A process according to claim 1 in which the ferric ion concentration in the first and second stages is from 30 to 100 mg/L Fe³⁺ as Fe.

22. A process according to claim 1 in which the ferric ion concentration in the first and second stages is from 50 to 80 mg/L Fe³⁺ as Fe.

23. A process according to claim 1 in which the co-precipitation is carried out in the presence of a flocculant and/or a coagulant.

24. A process according to claim 22 in which the first stage is carried out in the presence of an anionic polymer and the second stage in the presence of a cationic polymer.

25. A process according to claim 1 in which the nickel content in the final effluent is not more than 5 ppb and the selenium content is not more than 30 ppb.
